(19) United States
(12) Patent Application Publication
(10) Pub. No.: US 2021/0217413 A1
(43) Pub. Date: Jul. 15, 2021

(54) VOICE ACTIVATED INTERACTIVE AUDIO SYSTEM AND METHOD

(71) Applicant: Instreamatic, Inc., San Francisco, CA (US)

(72) Inventors: Stanislav TUSHINSKIY, Mountain View, CA (US); Ilya LITYUGA, Oryol (RU)

(21) Appl. No.: 16/060,839

(22) PCT Filed: Jun. 4, 2018
(86) PCT No.: PCT/US18/35913

§ 371 Date: Jul. 3, 2018

Related U.S. Application Data
(60) Provisional application No. 62/514,892, filed on Jun. 4, 2017.
(60) Provisional application No. 62/609,896, filed on Dec. 22, 2017.
(60) Provisional application No. 62/626,335, filed on Feb. 5, 2018.

(51) Int. Cl. G10L 15/22; G10L 15/30; G06Q 30/02

(52) U.S. Cl. CPC G10L 15/22; G10L 15/30; G10L 2015/223; G06Q 30/0267; G06Q 30/0271

(57) ABSTRACT

The present invention relates to systems and methods of digital interactions with users, and in particular systems and methods operating a voice-activated advertising system for any digital device platform that has connection to Internet and microphone. The systems and methods including the generation and digital insertion of pre-recorded audio advertisements or text-to-speech generated voice ads, followed by recording users' voice response to ad and understanding user's intents, providing ad response to user based on intents internal ad logic, and analysis of the end-user device and user data for further user engagement with the voice-activated audio advertisement. User interaction data is captured and analyzed in an Artificial Intelligence core to improve selection and delivery of interactions.

### CROSS-REFERENCE TO RELATED APPLICATIONS

The present application is a national stage application of PCT International Application Serial No. PCT/US18/35913, filed Jun. 4, 2018, which claims priority under 35 USC 119(e) of U.S. Provisional Applications 62/514,892; 62/609,896; and 62/626,335; filed on Jun. 4, 2017; Dec. 22, 2017; and Feb. 5, 2018; respectively, the discloses of each of these applications are hereby incorporated by reference herein.

### BACKGROUND OF THE INVENTION

### Field of the Invention

The invention relates to digital advertising software. More specifically, but not exclusively, the field of the invention is that of internet based interactive software for audio advertising over the internet.

### Description of the Related Art

Advertising is a key revenue generator for many enterprises both in offline media (TV, newspaper) as well as online (search/contextual, ad-supported media content services, mobile) whereby the latter already represents S79 billion in the US alone, soon to surpass all TV advertising. However, the vast majority of untapped “ad inventory” for advertising resides with voice communications themselves. Voice communication is the most native, natural and effective form of human-to-human communication, and with dramatic improvements in speech recognition (Speech To Text, or STT) and speech synthesis (Text To Speech, or TTS) technology over the past years, so too is the natural progression for human-to-machine communication becoming native and replacing the habit for tapping and swiping on smartphone screens, accelerated by voice-first platform devices such as Amazon Alexa® (Alexa® is a registered trademark of Amazon Technologies, Inc. of Seattle, Wash.), Google Home (Google Home is an unregistered tradename of Alphabet, Inc. of Mountain View, Calif.), Samsung Bixby® (Bixby® is a registered trademark of Samsung Electronics Co., Ltd. of Suwan, Gyeonggi-do province of South Korea), and similar devices.

Such voice communications may be processed by PCs, laptops, mobile phones, voice-interface platform devices (Amazon Alexa®, Google Home, etc) and other end-user devices that allow user-specific communications. For that matter, even some point-of-sale (POS) devices allow interactive, voice-activated communication between a user and an automated response system, and may also allow for advertising/sponsor messaging.

In general, today digital audio ads replicate radio advertising being 30 second-long pre-recorded audio messages without any engagement ability. Digital audio advertisement is the choice of top-tier brands who strive after brand image enhancement. At the same time it is a great tool for small and medium businesses who want to reach greater audience yet have limited budget.

### SUMMARY OF THE INVENTION

The present invention relates to the field of digital advertisements, and in particular the present invention relates to the system and method in operating a voice-activated advertising solution for any digital device platform that has connection to Internet and microphone built-in, including generation and digital insertion thereof, pre-recorded audio ad or text-to-speech generated voice ad, recording users' voice response to ad and understanding user's intents, providing ad response to user based on intents internal ad logic, analysis of the end-user device and user data for further user engagement with voice-activated audio advertisement.

Voice communications include a significant amount of information that may help target advertisements to users. This is information that is not utilized today. A problem for media companies and audio publishers is advertising injection during hands-free and screen-free interaction with devices and/or audio content consumption. Developments and adoption of voice interfaces among users is making possible to create and serve voice-activated ads that may serve responses to user's commands.

The present invention includes methods and systems of serving and delivery of advertisements and subsequent end-user interaction via voice with the advertisement. Also described herein are methods of computing device's reactions to the various voice commands by the end-user, received upon the initial advertising message as well as on the subsequent responses by the computer program. The result of the voice interaction involve targeted actions which include, but are not limited to: dial number, text message, open link in browser, skip advertising, request for more information, add event to calendar, add product to shopping cart, set up reminder, save coupon, add task to to-do list, etc.

Embodiments of the invention provide schematic and method of interaction of the end-user device with the voice recognition system and its subsequent interpretation into one or another targeted actions by the management system of the advertising network, including in itself an Ad Serving Module, Ad Logic, Ad Analysis and interaction with Ad Serving with Text-to-speech (TTS) system.

A first aspect of the invention includes the method of ad view request with information about user and his/her current environment. The method may include the user device sending its request to ad network to obtain advertisement. Such a request may include information about ad format, user information such as social and demographic characteristics, interests, current location, current business (current context), etc. The method allows the receipt of a current ad offer (if any) at the most appropriate time to be of interest to the user.

A second aspect of invention includes the method of ad offer selection for the user. In this aspect, the method involves the ad network analysing data received upon request received from the user device, compares it with the current offers and advertiser requirements for the target audience, and selects the optimal offer for the current user based on the above data, as well as based on analysis of other users' reaction to similar ad offers. As a result, the offer selected is one which is more likely to be of interest to the user.

A third aspect of invention includes ad message generation for user. In advertising campaigns, where applicable, based on the ad offer selected, advertising network AI Core analyses data specified in the second aspect, and also analyses historical data on different categories of users' reaction to various advertising messages. In the event the advertising campaign already contains an advertising message which was provided by the advertiser, AI Core analyses expected effectiveness of such message. Following the results of the analysis, an advertising message is generated, which may include text, sound and visual content taking into account any features of a particular user and his environment. The method generates actual advertising messages which are more likely to be of interest to the user at a given time. In addition, this aspect allows for the generation of response messages to the user's reaction, thereby keeping dialogue with the user.

A fourth aspect of invention includes advertising message transfer to the user. In this aspect of the method, messages are generated in the ad network and transferred to the user device. This method provides the transfer of instantaneously current advertising messages to the user, whenever applicable, thereby increasing interactivity of interaction.

A fifth aspect of invention includes the method of user interaction with advertising message via the user voice. In this aspect, the method with which the user may use voice to dial a telephone number, text a message, open a link in browser, skip advertising, request for more information, add an event to his calendar, add a product to shopping cart, set up a reminder, save a coupon, add a task to to-do list, etc. The command is recognized on the device or in the Voice recognition and interpretation network, interpreted and executed accordingly. The method ensures appropriate interaction with the user and thereby increases user involvement in the process.

A sixth aspect of invention includes constant improvement of quality of the ad offers selected and advertising messages generation. In this aspect, the method with which the ad system fixes all and any results of interaction with the users and uses this data in further work for analysis in new offers selection and new messages generation. This aspect of the method constantly improves in quality of advertisement for the user, thereby increasing conversion.

A seventh aspect of invention includes software for above methods implementation and interaction support with other software components which are used in the ad systems. Implementation may include several interrelated features: Ad Injection to receive and reproduce advertisement on users' devices; Ad Platform Interface to implement interface, which provides for interaction between the users' devices and ad network; Ad Server to organize interaction between ad network and user's devices; Ad Logic to organize interaction between various components of ad network with each other, to select ad offers for users and account for requirements of advertisers; Data Management Platform to store and access data about users and their devices; AI Core to generate targeted messages for users; Text to Speech to convert text into voice speech; Voice Recognition to recognize user's voices; and Voice Command Interpretation to interpret recognized voice into specific commands—all of which are tailored for the unique characteristics of voice interaction, particularly on mobile devices.

Embodiments of the invention relate to a server for enabling voice-responsive content as part of a media stream to an end-user on a remote device. The server includes an app initiation module configured to send first device instructions to the remote device with the stream. The first device instructions include an initiation module that determines whether the remote device has a voice-responsive component, and upon determination of voice-responsive component activates the voice-responsive component on the user device and sends the server an indication of the existence of the voice-responsive component. The server also includes an app interaction module configured to send the remote device second device instructions. The second device instructions include an interaction initiation module that presents an interaction to the user over the user device. The interaction initiation module then sends the server voice information from the voice-responsive component of the end user device. The server further includes an app service module configured to receive the voice information and interpret the voice information. The app service module creates and sends third device instructions to the remote device to perform at least one action based on the voice information. Optionally, the server includes an AI core module configured to collect data including the second and third device instructions with the corresponding voice information and interpretation and the at least one action. The AI core module is configured to analyze the collected data, and generate interactions for the app interaction module.

The app interaction module may present the interaction to the user concurrently with presenting the media stream to the user. The app initiation module may also send the AI core module information about the end-user and the remote device, wherein the app interaction module may create the interaction based on the information about at least one of the end-user and the remote device.

The app service module at least one further action includes generating another interaction for presentation by the app interaction module. The presentation of the interaction includes at least one of between items of content of the media stream, concurrently with the presentation of the media stream, during presentation of downloaded content, and while playing a game. The app service module may further include natural language understanding software. The app service module is configured to provide as a third device instruction a further interaction initiation module that presents a further interaction to the user over the user device. The app service module is further configured to create the third device instructions based on an end-user voice response and available data about previous interaction of the user and data about the remote device. Additionally, the app service module is configured to create a voice response to the user. The app interaction module is also configured to collect and processes data related to previous end-user interactions, data available about the end-user, and data received from the remote device, and use the collected data to generate the second device instructions to present a customized interaction. The app interaction module is configured to create second device instructions to mute the media stream and present an interaction as audio advertisements as a separate audio stream.

### BRIEF DESCRIPTION OF THE DRAWINGS

The above mentioned and other features and objects of this invention, either alone or in combinations of two or more, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system in which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized in conjunction with embodiments of the present invention.

FIG. 3 is a high-level diagram of a system that is operable to perform a method for serving voice-responsive advertising with multi-stage interaction by means of voice interface.

FIG. 4 is a high-level diagram of modules and components responsible for the logical workings and processing of information required for the serving of advertisements, receival of voice responses from the end-user, determination of user's intent, selection and delivery of the reply/answer to the end-user.

FIG. 5 is a flow chart diagram of a method used to deliver ads, receive voice response from user, perform text-to-speech and further intent interpretation, decide and deliver response to user's initial voice response.

FIG. 6 is a schematic block data flow diagram of AI core operation.

FIG. 7 is a flow chart diagram of one embodiment of an algorithm for AI core operation.

FIG. 8 is a schematic diagram of interaction between AI core with external software components included into integrated advertisement system.

FIG. 9 is a schematic block data flow diagram of another embodiment of interactive audio advertisement.

FIG. 10 is a schematic block data flow diagram of a further embodiment of interactive audio advertisement.

FIG. 11 is a flow chart diagram of an interactive audio advertisement when the listener's device receives the data needed to perform voice commands while the advertisement is playing from the broadcaster.

FIG. 12 is a flow chart diagram of interactive audio advertisement, in which the listener's device, during the reproduction of advertisement, identifies it and sends it to the advertisement system, receiving in return the data necessary for the execution of voice commands.

FIG. 13 is a flow chart diagram of interaction of software for the playback of interactive advertisement with external software components as part of an integrated advertisement system.

Corresponding reference characters indicate corresponding parts throughout the several views. Although the drawings represent embodiments of the present invention, the drawings are not necessarily to scale and certain features may be exaggerated in order to better illustrate and explain the full scope of the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings. While technology should continue to develop and many of the elements of the embodiments disclosed may be replaced by improved and enhanced items, the teaching of the present invention are inherent in the disclosure of the elements used in embodiments using technology available at the time of this disclosure.

The detailed descriptions which follow are presented in part in terms of algorithms and symbolic representations of operations on data bits within a computer memory representing alphanumeric characters or other information. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation. By changing the organization and operation of data structures and the algorithms for manipulating data in such structures, the fundamental operation of the computing system may be changed and improved.

Further, the manipulations performed are often referred to in terms, such as comparing or adding, commonly associated with mental operations performed by a human operator. No such capability of a human operator is necessary, or desirable in most cases, in any of the operations described herein which form part of embodiments of the present invention; the operations are machine operations. Useful machines for performing the operations of one or more embodiments of the present invention include general purpose digital computers or other similar devices. In all cases the distinction between the method operations in operating a computer and the method of computation itself should be recognized. One or more embodiments of present invention relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

Some embodiments of the present invention also relate to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipments through signals configured to particular protocols which may or may not require specific hardware or programming to interact. In particular, various general purpose machines may be used with programs written in accordance with the teachings herein, or it may prove more convenient to construct more specialized apparatus to perform the required method steps. The required structure for a variety of these machines will appear from the description below.

Embodiments of the present invention may deal with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system may be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which may be activated directly or indirectly by the user. The terms “windowing environment”, “running in windows”, and “object oriented operating system” are used to denote a computer user interface in which information is manipulated and displayed on a video display such as within bounded regions on a raster scanned, liquid crystal matrix, or plasma based video display (or any similar type video display that may be developed). The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks may access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis. A “module” refers to a portion of a computer system and/or software program that carries out one or more specific functions and may be used alone or combined with other modules of the same system or program.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a world wide network of computers, namely the “World Wide Web” or simply the “Web”. Examples of Browsers compatible with one or more embodiments of the present invention include the Chrome browser program developed by Google Inc. of Mountain View, Calif. (Chrome is a trademark of Google Inc.), the Safari browser program developed by Apple Inc. of Cupertino, Calif. (Safari is a registered trademark of Apple Inc.), Internet Explorer program developed by Microsoft Corporation (Internet Explorer is a trademark of Microsoft Corporation), the Opera browser program created by Opera Software ASA, or the Firefox browser program distributed by the Mozilla Foundation (Firefox is a registered trademark of the Mozilla Foundation). Although the following description details such operations in terms of a graphic user interface of a Browser, one or more embodiments of the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method). Similarly, JavaScript Object Notation (JSON) may be used to convert between data file formats.

The terms “personal digital assistant”, or “PDA”, or smartphone as defined above, means any handheld, mobile device that combines two or more of computing, telephone, fax, e-mail and networking features. The terms “wireless wide area network” or “WWAN” mean a wireless network that serves as the medium for the transmission of data between a handheld device and a computer. The term “synchronization” means the exchanging of information between a first device, e.g. a handheld device, and a second device, e.g. a desktop computer or a computer network, either via wires or wirelessly. Synchronization ensures that the data on both devices are identical (at least at the time of synchronization).

Data may also be synchronized between computer systems and telephony systems. Such systems are known and include keypad based data entry over a telephone line, voice recognition over a telephone line, and voice over internet protocol (“VoIP”). In this way, computer systems may recognize callers by associating particular numbers with known identities. More sophisticated call center software systems integrate computer information processing and telephony exchanges. Such systems initially were based on fixed wired telephony connections, but such systems have migrated to wireless technology.

In wireless wide area networks, communication primarily occurs through the transmission of radio signals over analog, digital cellular or personal communications service (“PCS”) networks. Signals may also be transmitted through microwaves and other electromagnetic waves. Much wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet-data technology over analog systems such as cellular digital packet data (“CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system which allows for application programs to be implemented on a mobile device such as a mobile telephone or PDA. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.), and Windows Phone 7. “Mobile Apps” refers to software programs written for execution with Mobile Software.

“Speech recognition” and “speech recognition software” refers to software for performing both articulatory speech recognition and automatic speech recognition. Articulatory speech recognition refers to the recovery of speech (in forms of phonemes, syllables or words) from acoustic signals with the help of articulatory modeling or an extra input of articulatory movement data. Automatic speech recognition or acoustic speech recognition refers to the recovery of speech from acoustics (sound wave) only. Articulatory information is extremely helpful when the acoustic input is in low quality, perhaps because of noise or missing data. In the present disclosure, speech recognition software refers to both variations unless otherwise indicated or obvious from context.

“AI” or “Artificial Intelligence” refers to software techniques that analyze problems similar to human thought processes, or at least mimic the results of such thought processes, through the use of software for machine cognition, machine learning algorithmic development, and related programming techniques. Thus, in the context of the present invention, AI or Artificial Intelligence refers to the algorithmic improvements over original algorithms by application of such software, particularly with the use of data collected in the processes disclosed in this application.

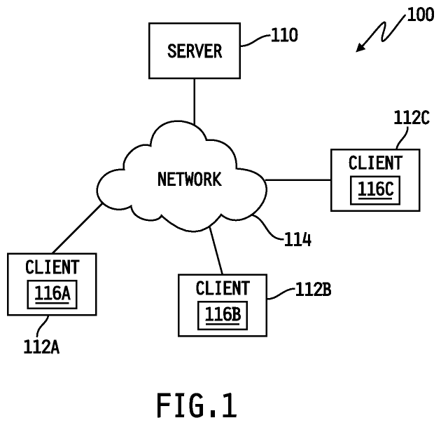

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

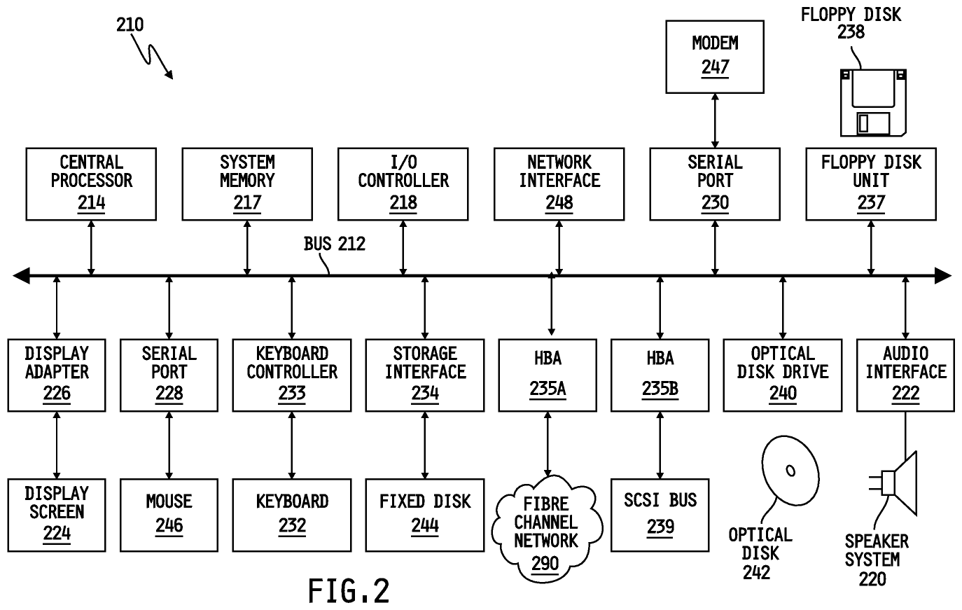

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238 (disk drive 237 is used to represent various type of removable memory such as flash drives, memory sticks and the like), host bus adapter (HBA) interface card 235A operative to connect with Fibre Channel network 290, host bus adapter (HBA) interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally main memory into which operating system and application programs are loaded. ROM or flash memory may contain, among other software code, Basic Input-Output system (BIOS) which controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system. In some embodiments, computer system 210 may take the form of a tablet computer, typically in the form of a large display screen operated by touching the screen. In tablet computer alternative embodiments, the operating system may be iOS® (iOS is a registered trademark of Cisco Systems, Inc. of San Jose, Calif., used under license by Apple Corporation of Cupertino, Calif.), Android® (Android is a trademark of Google Inc. of Mountain View, Calif.), Blackberry® Tablet OS (Blackberry is a registered trademark of Research In Motion of Waterloo, Ontario, Canada), webOS (webOS is a trademark of Hewlett-Packard Development Company, L.P. of Texas), and/or other suitable tablet operating systems.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

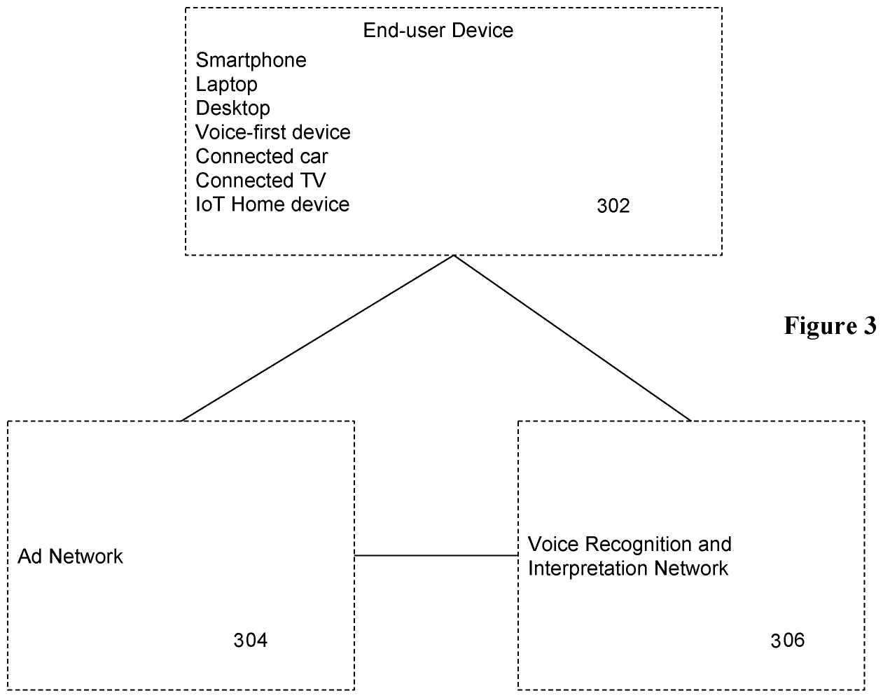

FIG. 3 is a high-level diagram of a system that is operable to perform a method for serving voice-responsive advertising with multi-stage interaction by means of a voice interface.

The diagram of FIG. 3 shows how a program application on end-user device 302 (which may be a digital radio app, music service, game, activity app, etc.) according to internal logic sends the advertising request, including available data about the user's device, data from user's device including gyroscope position, gps data, etc., anonymized data about the user, to Ad Network 304. On the basis of processing results of received data and other available data, Ad Network 304 sends advertising materials into the application, which may include text, audio and video material. During the reproduction of the advertisement or after a special identified moment within the advertisement itself, an App on user device 302 turns on the user's device microphone and begins to record audio. At this time, with his/her voice the user may say a voice command, which the Ad Platform (typically a part of Ad Network 304, but in some embodiments many be separate and distinct) sends the recorded audiofile via an interface to speech recognition system 306. The user's speech recognized in form of words is sent to the interpretation module (typically part of network 306, but in some embodiments may be separate and distinct), which interprets the words into targeted actions. The speech interpretation module determines the highest probability targeted actions and informs of this to Ad Network 304. On the basis of internal logic and methods, Ad Platform determines the answer to the user, which is then sent to end user device 302 in the form of audio, video, text and other information. The user may subsequently upon receiving the answer, begin interaction again and the method of interaction may be repeated.

As described above, the end-user's device serves as the interface for interaction with the user, as well as initiating receival of advertisement and may itself provide the speech recognition if its operating software supports such functionality. The computer operation and structure of the Ad Network, the Ad Platform, Ad injection software and related items are known and thus are not described in detail to facilitate the understanding of the present invention.

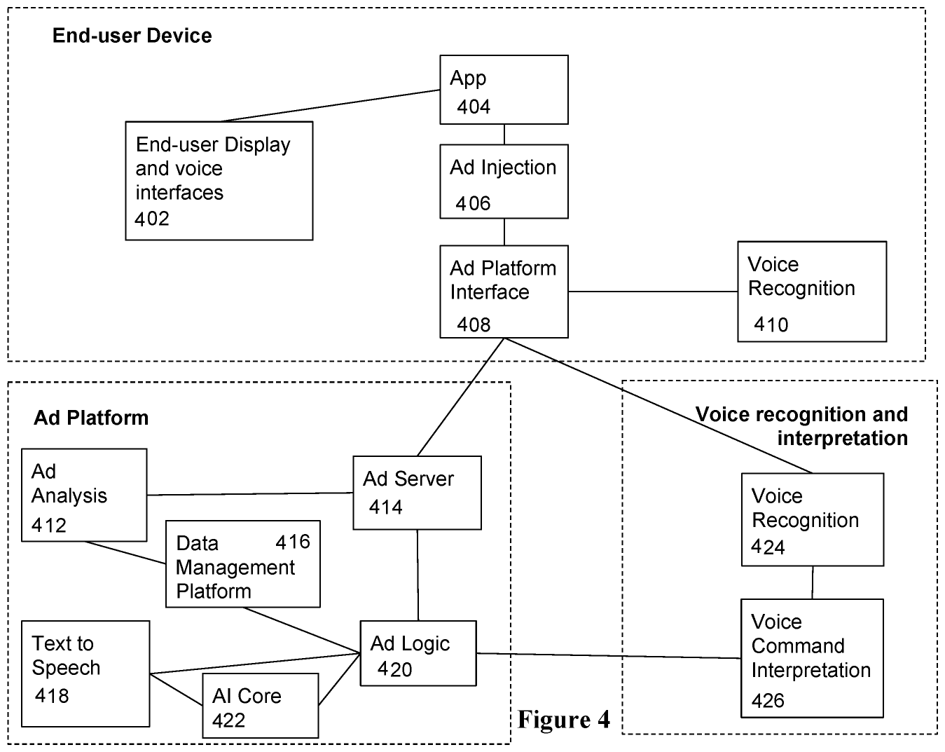

FIG. 4 illustrates the interaction and working logic of various components which may be used in the delivery of multi-stage voice-responsive advertising.

Ad injection software 406 on end-user application 404 serves ad and begins to recognize speech. If end-user's device supports speech recognition then conversion of speech into text is processed on the device, if not then Ad Injection 406 sends the recorded audiofile with user's response via Ad Platform Interface 408 to speech recognition system 424. The recognized speech in the form of received text words is sent to Speech Interpretation Module 426 to determine from the word text which targeted actions are most applicable. Speech Interpretation Module 426 determines which is the highest probability targeted action the user responded with his voice to the advertisement. Targeted actions may include, but are not limited to, the following: dial number, text message, open link in browser, skip advertising, tell more information, add event to calendar, add product to shopping cart, set up reminder, save coupon, add task to to-do list, etc.

The received interpretation is transmitted to Ad Logic system 420, which records the received data at Data Management Platform 416 and determines which should be the performed reaction to the user's request.

Ad Logic 420 performs computation according to algorithms which take into account available data about the ad recipient and objectives of the advertiser, such algorithms being known in the art. Ad Logic 420 uses, but is not limited to, the following data sets involved in processing of end user's data with the purpose of generating of the most engaging answer: end user's ad engagement history, ad format usage pattern history, advertised products, reactions to separate stimulating words (e.g. “only today”, “right now”, end user's name, “discount”, “special offer”, “only for you” etc.), end user's preferred method of reaction to advertisement (call, skip, receive more info, etc), clearly defined brand preferences, collected anonymized data about the user, current anonymized data from the end user device including GPS position, data about end user contact with other ad formats (banner, video ads, TV, etc).

In the processing of the advertiser's goals Ad Logic 420 considers, including but is not limited to, the following data sets: format of the targeted action (opening link, phone call, a full informing about the product, etc.), geolocation about the nearest point of sale relative to the end user, history of purchases for the purpose of narrowing the product specification for product offer (for example, in an advertisement for a coffee shop, the end user will be offered to voice the preferred method of his coffee preparation, instead of just coffee in general), ability to change the communication content of the advertisement, consumer preferences of the competitions' products.

Ad Logic 420 determines the most relevant response to the user, by analyzing available data weighed with dynamic coefficients according to the inputted logic and advertising campaign goals, which optimally satisfies both the user's and advertiser's request.

If an ad campaign supports automatic generation of ad responses, then Ad Logic 420 sends the request for answer generation in text form to AI Core 422. AI Core 422 generates the answer in the form of text on the basis of both predetermined algorithms and available data, including but not limited to: user data including sex, age, name, context of the advertisement, name of product advertised, targeted action and essence of the response communication determined by Ad Logic 420, history of interaction with ad, etc.

AI Core 422 may also direct text response to Text-to-Speech (TTS) Module 418 for the machine-generated speech answer, which may then be transferred to Ad Logic 420.

Ad Logic 420 informs Ad Serving 414 which audio/video/text material should be transferred to the user as the reaction to his voice command. Ad Serving 414 sends the advertising material or other instructions via Ad Platform interface 408, which represents the response reaction to the user's voice command.

The user may react to the received reaction for subsequent initiation of method of voice responsive reaction to the advertisement. In the case it was determined that the user instructed the skip command or to terminate the advertisement, Ad Platform informs App 404 the advertising interaction is completed and that it is time to return to the main functions/content of App 404.

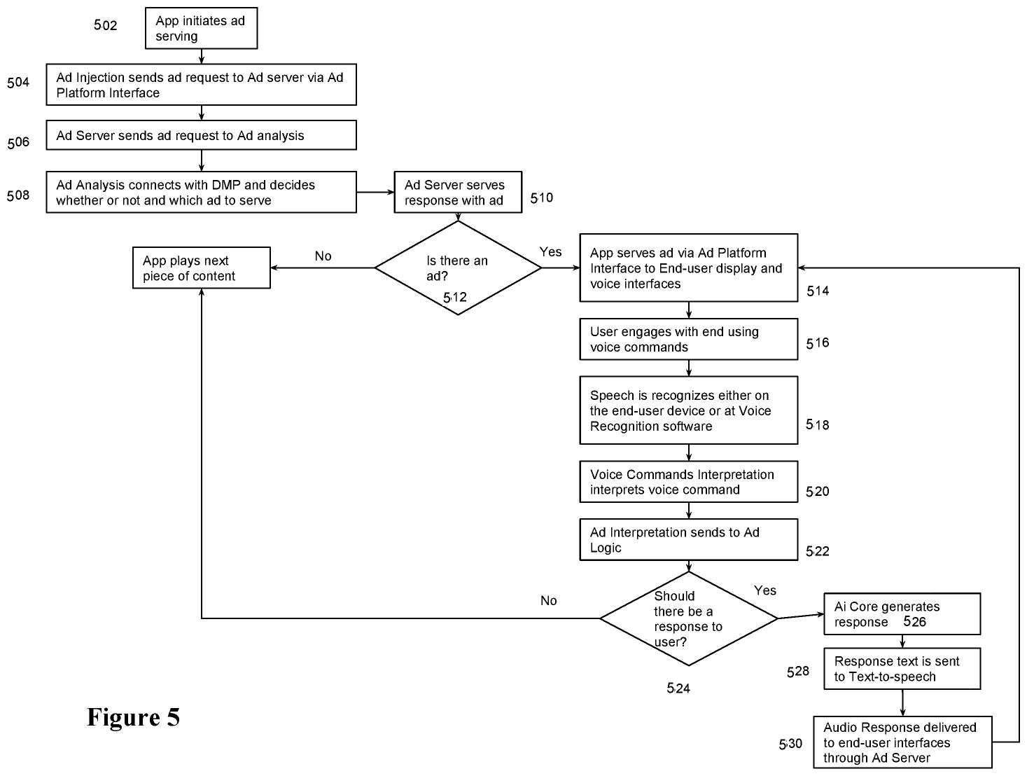

FIG. 5 illustrates an exemplary flow chart of the method described herein.

In step 502, App 404 initiates Ad serving request to Ad Injection software 406. As an alternative Ad Injection may send ad request to Ad Network 304 to download and save ad in cache of End-user Device 302 before receiving a request from App 404.

In step 504, Ad Injection software 506 sends ad request to Ad Network Interface 408 which forwards ad request to Ad Server 414 providing details of the ad format requested and available data from End-user Device 302.

In step 506, Ad Server 414 sends ad request to Ad Analysis 412 which process all active ads and choses the best suited for this particular device taking in consideration internal data of each ad campaign including prices, frequency, etc.

In step 508, Ad Analysis 412 sends request for additional data about the end-user device to Data Management platform 416 to perform better ad targeting. After processing all data, Ad Analysis 412 determines if an ad should be served and which ad to serve. Ad Analysis 412 sends response with ad or negative response to Ad Server 414.

In step 510, Ad Server 414 serves ad or negative response to App 404 via Ad Platform Interface 408 and Ad Injection 406.

In step 512, App 404 process its internal logic depending on response from Ad Network 304. If there is no ad, then App 404 delivers next piece of content.

In step 514, App 404 communicates an ad to the user via End-user Display and Voice Interface 402. In some cases, like radio streaming, Ad Injection 406 may manipulate App's content to serve the ad over the streaming (that is to say that the audio add has a volume sufficient to be separately understood from the streaming audio).

In step 516, user engages with ad using voice commands. As part of ad session user first listens to audio/video ad content and may respond with a voice command during or after the ad content. User may ask to skip an ad, ask for more information, ask to call a company, etc.

In step 518, user's speech is recognized either on the end-user device or on voice recognition 424.

In step 520, Voice Command Interpretation 426 processes incoming user command in the form of text and with different level of probability it chooses which command has the highest probability among all possibilities to be asked by user.

In step 522, Ad Interpretation sends the result with the highest probability to Ad Logic 420.

In step 524, Ad Logic sends either negative response (if the user asked to skip an ad) to Ad Server 414 which forwards it to App 404. If users said one of voice commands Ad Logic 420 sends request for generating a response to AI Core 422.

In step 526, AI Core 422 processes the user's request and data available to generate text response.

In step 528, AI Core 422 sends final text response to Text To Speech 418 to record audio response based on the text.

In step 530, AI Core forwards audio response to Ad server 414 via Ad Logic 420 which saves the data of this interaction. Ad Server 414 communicates the ad through Ad Platform Interface 408 and Ad Injection 406 to End-user Display and Voice Interface 402. User may repeat the flow with the next voice command to the audio response from Ad Network 304.

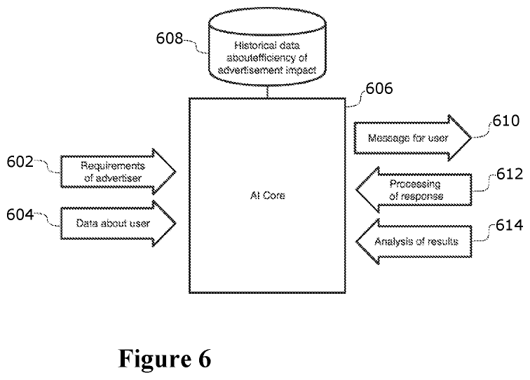

FIG. 6 shows a schematic block data flow diagram of AI core operation. Information about requirements of advertiser 602 and data about current user 604 which needs to be shown the advertisement is transferred to AI core 606.

Requirements of advertiser 602 to the target audience may include the following data: Social-demographic properties—location, sex, age, education, marital status, children, occupation, level of income; Interests; Locations where display of advertisement will be relevant—city, street, specific location, on the map or all streets in the indicated radius from the point selected on the map; Requirements to advertisement—text blanks or complete texts of advertisements; Target action which a user must perform after listening to advertisement.

An option is allowed when there are no requirements of advertiser except the requirement to target action. In this case AI core 606 issues them on its own based on historical data about efficiency of the advertisement impact.

Data about user 604 may include: Social-demographic properties—location, sex, age, education, marital status, children, occupation, level of income; Interests; Current location; Current environment—what the user is doing, for example, if he is practicing sports, listening to music or podcast, watching movie, etc. Data about the user is received in anonymous form and does not allow identifying his person.

AI core 606 performs analysis on the basis of received data 602 and 604 and historical data about efficiency of advertisement 608 impact upon users. Analysis is done in terms of the following: Advertisements—current advertisement, other advertisements of advertising campaign, including analysis of voice and background supporting music; Campaigns—current campaign, other advertising campaigns of the advertiser, campaigns of other advertisers similar to the current one; Advertisers—all advertising campaigns of the advertiser, advertising campaigns of all advertisers, including analysis of perceptions of the advertisers by users; Users—current user, users similar to the current one, all users, including analysis by social-demographic data, location and environment, analysis of responses. As a result of analysis based upon data about the user, advertising campaign, advertiser and historical data AI core through machine learning techniques determines the best combinations of parameters that influence efficiency of advertisement, issues the text, selects voice, background music (if required) and visual component (if required) for advertisement message 610 and sends it to the user. When a response is received from user 612 the component processes it to make a decision about further actions: whether to issues a new message with requested information, ask a clarifying question or to terminate the dialog. When the dialog is finished, the component analyses its results 614 for their recording into base of historical data about efficiency of advertisement 608 efficiency.

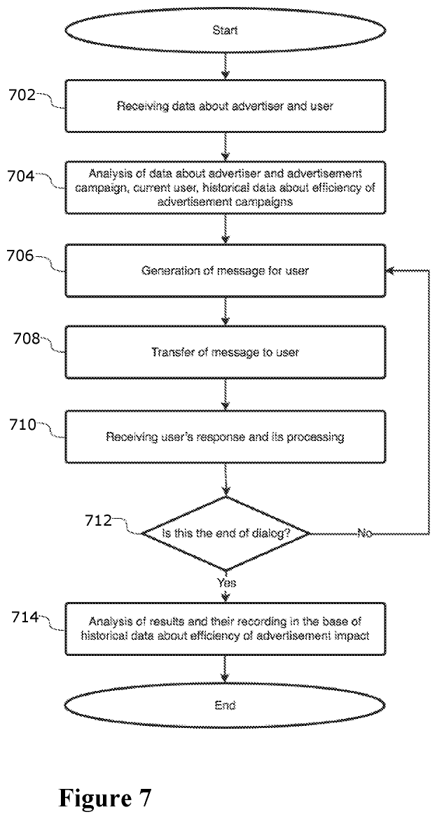

FIG. 7 illustrates one embodiment of an algorithm for AI core operation. At step 702 AI core receives data about current user, advertiser and his requirements. At step 704 AI core performs analysis on the basis of received data 602 and 604 and historical data about efficiency of advertisement impact onto user 608. At step 706 AI core generates message for user 610. At step 708 AI core transfers advertisement to the user or to another software component for sending to the user. At step 710 AI core receives response from use 712, processes and interprets it. At step 712 AI core according to the results of step 710 determines current condition of interaction with the user—is this the end of dialog with the user or a new (reply) message must be issued for him. If this is not the end of dialog, AI core returns to step 706 for generation of message. If this is the end of dialog, AI core proceeds to step 714. At step 714, AI core analyses the results of dialog with user 614 and accordingly refreshes base of historical data about efficiency of advertisement 608 impact.

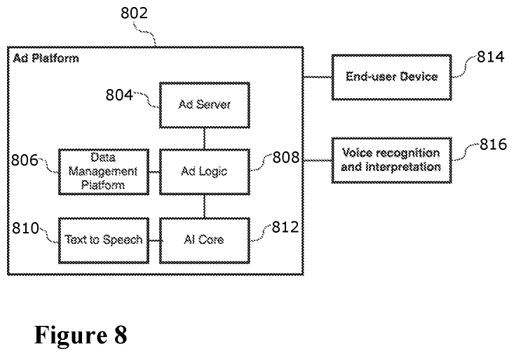

FIG. 8 schematically shows an exemplary embodiment of interaction between AI core with external software components included into integrated advertisement system. Advertisement platform 802 may include the following software components: Ad Server 804 for interaction between advertisement system and devices of users 814; Data Management Platform 806 for storage and access to data about users and their devices; Ad Logic 808 to select advertising campaign on the basis of advertiser's requirements, implementation of advertising system logics and ensuring interaction among all components as well as with the component for users' 816 responses recognition and interpretation; Text to Speech 810 to convert text into speech; AI Core 812 similar to that described above.

AI core for voice recognition and interpretation of user's 816 response provides both recognition and interpretation of user's response, and transfer of interpretation result to Ad Logic 808.

Various features of Ad Logic 808 include: Receiving data from AI core for recognition and interpretation of response from user 816; Sending query to Data Management Platform 806 to receive supplementary information about the user; Recording data about user in Data Management Platform 806; Selecting advertising campaign for the user; Sending information to Ad Server 804 about what advertisement to shown; Making decision about processing of recognized user's response; Transfer of data to AI Core 812 for issuing advertisement message to the user; Receiving completed advertisement message from AI Core 812; Transfer of advertisement message to Ad Server 804 that was issued in AI Core 810.

Various features of Text to Speech 810 include: Receiving query from AI Core 812 to convert the text of advertisement message into speech; Returning result of conversion to AI Core 812.

Various features of Data Management Platform 806 include: Storage and accumulation of data about the users and their devices; Providing access to data for other AI cores of platform 802.

Various features of Ad Server 804 include: Receiving queries from the devices of users 814 for showing of advertisement; Sending query to Ad Logic 808 to select advertising campaign; Receiving advertisement message from Ad Logic 808; Sending advertisement message to the device of user 814.

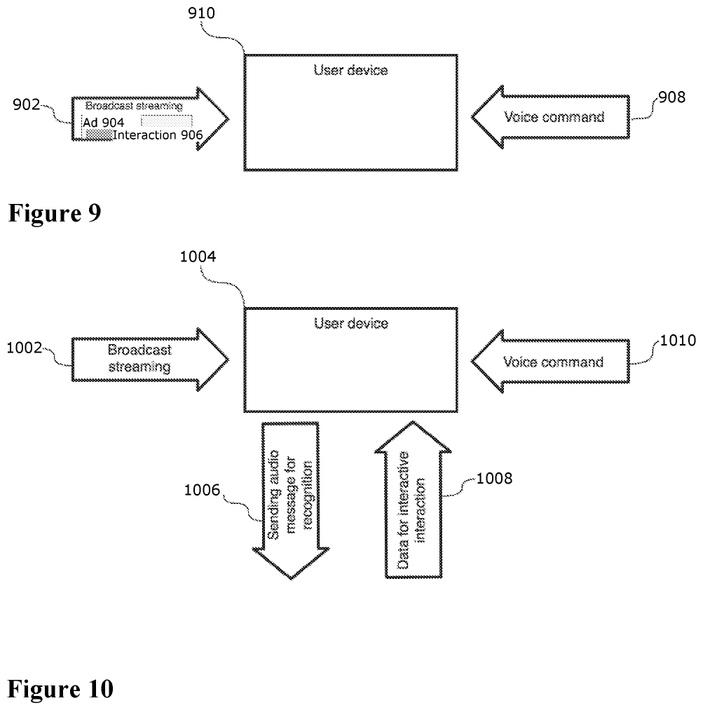

FIG. 9 is a schematic diagram of another embodiment of interactive audio advertisement, in which the data necessary for the performance of voice commands are transmitted during the reproduction of advertisement from the broadcaster. In this embodiment, the broadcaster provides streaming audio and/or audio-visual information stream 902, including data streams for advertisement 904 and interaction information 906 necessary for the performance of voice commands, along with the main stream of the broadcast.

User's device 908 receives the broadcast 1.1, which includes the advertisement message 1.1.1 and extracts the information 1.1.1.1 from it for the execution of commands. The information may include the following data: link to a web resource; phone number; e-mail address; date and time for adding the advertised event to the calendar; geographical coordinates; SMS text/text for a messenger; USSD request; web request to execute a command, and other related information.

Next, the listener device is switched to the standby mode, waiting for a voice command from the user.

When voice command 908 is received from the listener, device 910, based on this command and received interaction information 906, performs the specified action, for example, calls a phone number or requests the user to repeat the command Commands 908 may initiate the following actions on the user device 910: click-through or download of a file; telephone call; creating and sending an email; calendar entries; building a route from the current location of the user to the destination point; creating and sending SMS messages, messages in instant messengers or social networks; sending a USSD request; calling the online service method; adding a note; and other related functions.

FIG. 10 contains an alternative embodiment of interactive audio advertisement, in which the listener's device, during the reproduction of advertisement, identifies it and sends it to the advertisement system, receiving in return the data necessary for the execution of voice commands. The broadcaster broadcasts 1002, and user device 1004 receives broadcast 1002, reproduces it and sends received stream 1006 to the advertisement system for recognition of advertisement. The advertisement system performs the analysis and recognition of advertisement in the stream received from the user's device. In case of successful recognition, the advertisement system returns to the user device 1004 the information 1008 necessary to execute the commands associated with this advertisement. The list of sent information is given above. If the advertisement message is not recognized, data transmission to user device 1004 is not performed. Next, the listener device 1004 is switched into standby mode, waiting for a voice command 1010 from the user. When the voice command 1010 is received from the listener, the device, based on this command and the received information, performs the specified action, for example, calls a phone number or requests the user to repeat the command. The list of user commands is given above.

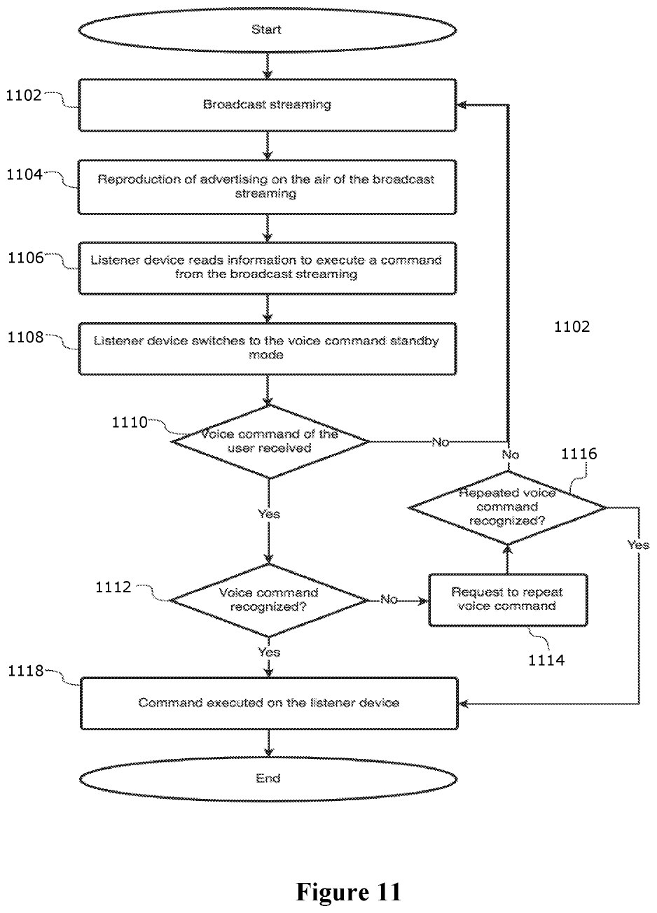

FIG. 11 shows an approximate scenario of an interactive audio advertisement when the listener's device receives the data needed to perform voice commands while the advertisement is playing from the broadcaster. In step 1102 the broadcaster streams live on the air. In step 1104 the advertisement is played on the air. In step 1106 the user device receiving the live broadcast gets the information required to perform the interactive operations. In step 1108 the user device is switched to the voice command standby mode. Step 1110 verifies that the device receives voice command while waiting. The following situations are possible: voice command received; or voice command not received.

If the device received the user's voice command, then it goes to step 1112, otherwise reception of broadcast 1102 continues. Step 1112 verifies recognition of the user's voice command by the device. The following situations are possible: voice command recognized, or voice command not recognized.

If the voice command is recognized, the command 1118 is generated and executed on the device using the information obtained in step 1106. Otherwise, the device generates a request to repeat command 1114. Step 1116 verifies recognition of the user's repeated voice command by the device. The following situations are possible: repeated voice command recognized, or repeated voice command not recognized.

If the repeated voice command is recognized, the command 1118 is generated and executed on the device using the information obtained in step 1106. Otherwise, the device informs the user about the error in receiving the voice command, while the broadcast 1102 continues.

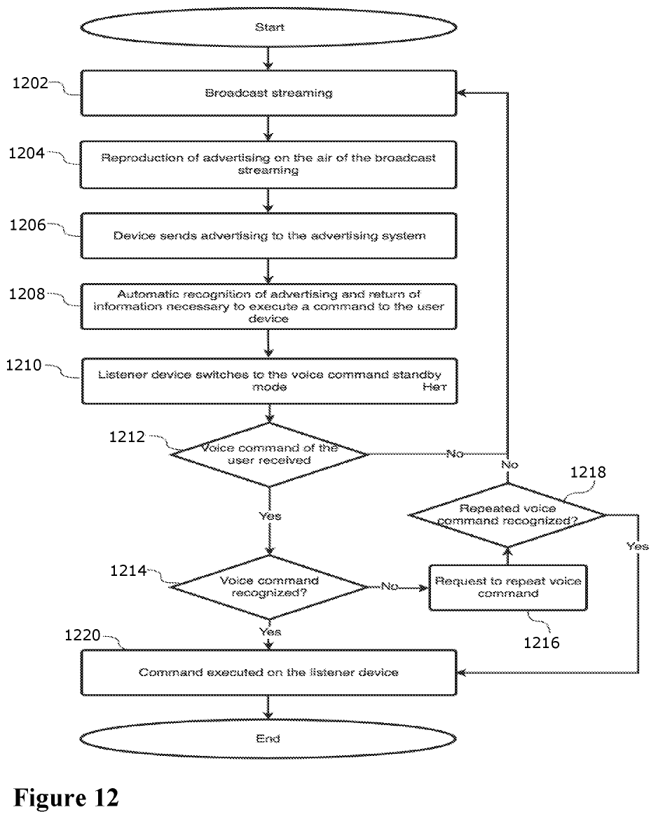

FIG. 12 shows another embodiment of interactive audio advertisement, in which the listener's device, during the reproduction of advertisement, identifies it and sends it to the advertisement system, receiving in return the data necessary for the execution of voice commands. In step 1202 the broadcaster streams live on the air. In step 1204 the advertisement is played on the air. In step 1206, the user device receiving the broadcast sends it to the advertisement system for analysis. In step 1208, the advertisement service identifies advertisements when it receives the input stream from the user device. Then it directs the associated advertisement information to the user's device to perform voice commands. In step 1210 the user device is switched to the voice command standby mode. Step 2112 verifies that the device receives voice command while waiting. The following situations are possible: voice command received, or voice command not received.

If the device received the user's voice command, then it goes to step 2112, otherwise reception of broadcast 1202 continues. Step 1212 verifies recognition of the user's voice command by the device. The following situations are possible: voice command recognized, or voice command not recognized.

If the voice command is recognized, the command 1220 is generated and executed on the device using the information obtained in step 1208. Otherwise, the device generates a request to repeat command 1216. Step 1218 verifies recognition of the user's repeated voice command by the device. The following situations are possible: repeated voice command recognized, or repeated voice command not recognized.

If the repeated voice command is recognized, the command 1220 is generated and executed on the device using the information obtained in step 1208. Otherwise, the device informs the user about the error in receiving the voice command, while the broadcast 1202 continues.

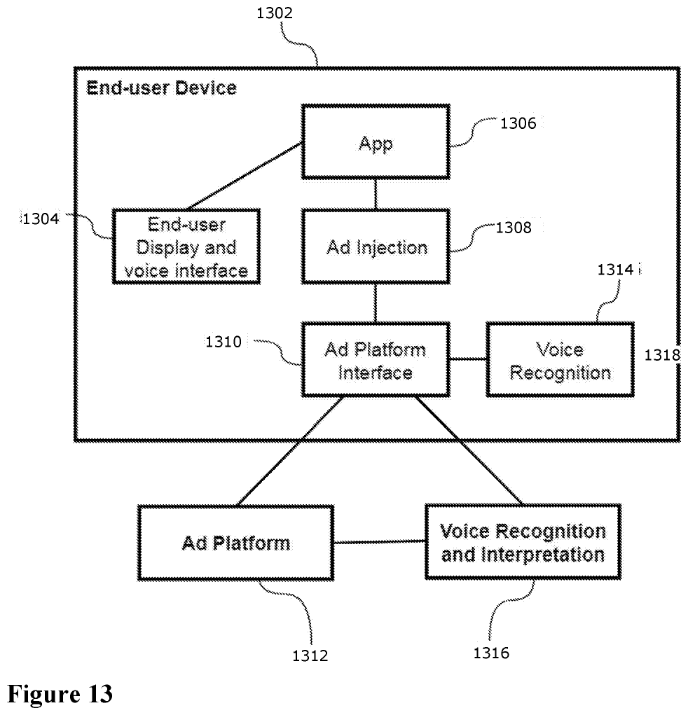

FIG. 13 contains an example of the interaction of software for the playback of interactive advertisement with external software components as part of an integrated advertisement system. The end user device 1302 may comprise the following components: End-user voice interface 1304—interface for receiving voice messages (microphone); App 1306, an application installed on the user device through which streaming broadcast is played; Ad Injection 1308, a module for placing information necessary for the execution of a voice command; Ad Platform Interface 1310, a component for communication with the Ad Platform 1312; Voice Recognition 1314, a module that manages the microphone of the user device and recognizes voice commands.

The user device interacts over the Internet with the following systems: Ad Platform 1312, an advertisement system; Voice Recognition and Interpretation 1316, a voice recognition system.

Various features of embodiments of the Ad Platform include: setting up an advertisement campaign and related information for the implementation of a command; receiving from the Voice Recognition and Interpretation module an interpreted user command; sending information related to the advertisement to the user device, it is necessary to execute user commands (participates in the implementation with the advertisement system).

Various features of embodiments of the Voice Recognition and Interpretation include: receiving broadcasts from the user device; stream analysis and ad allocation; ad recognition; Sending the identification information of the recognized advertisement to the Ad Platform 1312.

End-user Display and voice interface 1304 receives broadcast streaming. App 1306 plays the stream on the user's device. Ad Injection 1308 gets the information required to run voice commands from the input stream or from the ad Platform 1312. Voice Recognition 1314 receives the signals of appearing of advertisement on the air and waits for a voice command of the user.

Alternatively, when End-user Display and voice interface 1304 on the listener's device, during the playback of the advertisement, identifies it in Ad Injection 1308 and sends it to Ad Platform 1312 via Ad Platform Interface 1310, in response it receives the data necessary for performing voice commands Voice Recognition 1314 receives signals when the advertisement is on the air and waits for a voice command of the user.

When App 1306 receives a user's command recognized in Voice Recognition and Interpretation 1316 and information for the performance of voice commands obtained in Ad Injection 1308, it forms and implements an operation on the user device.

The aforementioned embodiments give specific examples of ways in which the present invention may be utilized. One advantage of embodiments of the present invention is that the server provides an end to end solution for voice activated end-user interactions. Typically, a remote device program for playing streaming, or in some cases downloaded, media activates those embodiments as the streaming media application is started on the remote device. Once the end-user device sends an affirmative message to the server that a microphone or other audio sensing device is available, the server drives the end-user interaction on the remote device by sending the remote device the interaction materials, the end-user interaction operates independently of the streaming media. For example, the text of an informational message or advertisement with one or more possible responses may be sent to the remote device and presented to the end-user by a text box on the remote device screen, or my an audio reproduction of the text played with the stream or between segments of the stream. Then the remote device obtains the voice information from the microphone and sends it to the server. Based on the voice information, the server may then send instructions to the remote device based on the end-user's response to the presented information.

As is know in the art, certain operations may be distributed amongst the server and the remote device. For example, the remote device may partially process the voice information before sending it to the server, it may completely interpret the end-user voice interaction and send the interpretation to the server, or it may simply record the end-user voice response and send the digital recording to the server.

Also, while the foregoing descriptions cover streaming media, that is audio and/or audio-visual streams of information that are transitorily stored on the remote device during the presentation of the audio or audio-visual, embodiments of the present invention also function with pre-recorded material that is downloaded to the remote device, for example podcasts. Ideally, the remote device plays the downloaded media and coordinates presentation of end-user interaction material at appropriate times or places in the presentation of the downloaded material in coordination with the server. Further embodiments allow the server to send the remote device potential end-user interaction material while connected to a network, for example in conjunction with the download, which may be activated by playing the downloaded material, even if the remote device is no longer connected to the network, e.g. the internet. To the extent possible, the remote device may execute some, if not all, of the operations, for example the remote device may have connection to telephony but not computer network resources, so a phone call might occur but a visit to a web site would not occur. Once the remote device is again connected, the results of the user interaction may be synched to the server.

In addition to the serving of user interaction in conjunction with a stream, the server further uses information about the end-user and the streaming content to create and/or choose an appropriate user interaction. The end-user information includes the end-user's prior actions and preferences. For example, one end-user may prefer making telephone calls (as indicated by a predominance of telephonic interactions) while another end-user may prefer interacting with web sites (again as indicated by a predominance of web site interactions).

Further to the disclosure of the present invention, user interactions include advertisements, but may be a variety of interactions from public service announcements to reminders from the end-user's own calendar or task list. Examples include, but are not limited to, an end-user having a task of getting milk, having the interaction module present the audio message “one of your tasks today is to get milk, would you like to see a map to the nearest grocery, or order the milk from your preferred vendor?” and enabling the remote device to either display a map to the nearest grocery or ordering milk from the end-user's preferred food delivery service. Similarly, the interaction module may present a public service announcement like “There is a sever thunderstorm predicted for your home in an hour, would you like to call home, have a map for the quickest route home, or a map to the nearest safe location?” and enabling the remote device to either call the home phone number or display the requested map.

The placement of the interactions may also be varied. As known in the art of serving advertisements, interaction material may be placed between pieces of streaming media content, e.g. between songs; over the content, e.g. superimposed on the existing audio during a radio streaming or a podcast; while playing a game, e.g., a background for the game or audio presented during the game, etc.

Embodiments of the invention also involve voice data collection. To enhance the AI capabilities, embodiments collect impersonal data from voice responses, like age range, gender, emotions involved in the interaction. This allows the AI component to better understand the user behavior and preferences so that future interactions are more compatible with the end-user. This voice information is included in the post interaction analysis, allowing for learning from end-user preferences and behavior. Embodiments also facilitate reporting on end-user behavior on the macro level to enhance interactions.

Further improvements in embodiments of the present invention involve the voice interpretation technology. Embodiments of the invention use natural language understanding (NLU), which does not require any specific keywords from end-users. By implementing NLU, embodiments of the invention allow end-users to express themselves in any way comfortable. This allows the standard software development kit (SDK) to be used by streaming media apps built for the remote device that covers any voice interactions, so that streaming media application developers don't need to have different SDKs for different use cases. In addition, advertisers are free to provide any ad content they feel comfortable with, meaning there are no restrictions on keywords to push to users. After a campaign starts using NLU, AI Core gathers data on user interaction to figure out how users respond to every single ad and adjust its understanding of intents based on that data.

Further embodiments include an exchange marketplace where various purveyors of interaction and publishers of streaming content may be connected. Organizations desiring interactions with end-users having certain characteristics viewing streaming media content of a specific nature may select end-user characteristics and/or streaming media content for initiation of interactions.

Embodiments of the invention provide several potential voice activations over a media stream (audio or audio-video) that are processed with associated meta-data which includes one or more of the following: phone number to dial, email to use, promo code to save, address to build route to, etc. For example, an end-user may listen to a local radio station through a mobile app, hear a standard radio ad, then say “call the company” and the remote device would then initiate a phone call. In some embodiments, such a scenario may occur by listening for a voice instruction during the ad break, while in other embodiments by using a wake-word like “hey radio” for initiation of the voice recognition. Embodiments of the invention initiate listening after receiving a request from an app on the remote device, or alternatively by tracking special markers which may be embedded in or recognized from the streaming media. This allows end-users to say voice-commands over a radio ad and the interaction module delivers results by knowing what number to dial, what email to use, etc.

Further embodiments of the invention utilize the AI core to create a new ad specifically for a particular end-user based on data previously collected from the end-user's interactions, other end-users interactions, and the target action of the sponsoring organization. AI Core creates and interaction based on what works best specifically for a particular organization in order to provide the highest ROI possible for organization. For example, if a coffee house wanted to encourage a customer to return for another purcahse, when the customer was sufficiently close to the coffee house the interaction module might present the following interaction: “Hey <name>, since you are nearby, how about that same cappuccino you ordered yesterday at the coffee house?”

While one or more embodiments of this invention have been described as having an illustrative design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A server for enabling voice-responsive content as part of a media stream to an end-user on a remote device, the server including:
app initiation module configured to send first device instructions to the remote device with the stream, the first device instructions including an initiation module that determines whether the remote device has a voice-responsive component, and upon determination of voice-responsive component activates the voice-responsive component on the user device and sends the server an indication of the existence of the voice-responsive component;
app interaction module configured to send the remote device second device instructions, the second device instructions including an interaction initiation module that presents an interaction to the user over the user device, and sends the server voice information from the voice-responsive component of the end user device to the server; and
app service module configured to receive the voice information and interpret the voice information, the app service module creating and sending third device instructions to the remote device to perform at least one action based on the voice information.

2. The server of claim 1 wherein the app interaction module presents the interaction to the user concurrently with presenting the media stream to the user.

3. The server of claim 1 wherein the app initiation module also sends the server information about the end-user of the remote device, and the app interaction module creates the interaction based on the information about at least one of the end-user and the remote device.

4. The server of claim 1 wherein the app service module third device instructions for at least one action includes another interaction for presentation by the app interaction module.

5. The server of claim 1 wherein presentation of the interaction includes at least one of between items of content of the media stream, concurrently with the presentation of the media stream, during presentation of downloaded content, and while playing a game.

6. The server of claim 1 wherein the app service module includes natural language understanding software.

7. The server of claim 1 wherein the app service module is configured to provide as a third device instruction a further interaction initiation module that presents a further interaction to the user over the user device.

8. The server of claim 1 wherein the app service module is configured to create the third device instructions based on an end-user voice response and available data about previous interaction of the user and data about the remote device.

9. The server of claim 1 wherein the app service module is configured to create a voice response to the user.

10. The server of claim 1 wherein the app interaction module is configured to collect and processes data related to previous end-user interactions, data available about the end-user, and data received from the remote device, and use the collected data to generate the second device instructions to present a customized interaction.

11. The server of claim 1 wherein the app interaction module is configured to create second device instructions to mute the media stream and present an interaction as audio advertisements in a separate audio stream.

12. A server for enabling voice-responsive content as part of a media stream to an end-user on a remote device, the server including:
app initiation module configured to send first device instructions to the remote device with the stream, the first device instructions including an initiation module that determines whether the remote device has a voice-responsive component, and upon determination of voice-responsive component activates the voice-responsive component on the user device and sends the server an indication of the existence of the voice-responsive component;
app interaction module configured to send the remote device second device instructions, the second device instructions including an interaction initiation module that presents an interaction to the user over the user device, and sends the server voice information from the voice-responsive component of the end user device to the server;
app service module configured to receive the voice information and interpret the voice information, the app service module creating and sending third device instructions to the remote device to perform at least one action based on the voice information; and
AI core module configured to collect data including the second and third device instructions with the corresponding voice information and interpretation and the at least one action, analyze the collected data, and generate interactions for the app interaction module.

13. The server of claim 12 wherein the app interaction module presents the interaction to the user concurrently with presenting the media stream to the user.

14. The server of claim 12 wherein the app initiation module also sends the AI core module information about the end-user and the remote device, and the app interaction module creates the interaction based on the information about at least one of the end-user and the remote device.

15. The server of claim 12 wherein the app service module at least one further action includes generating another interaction for presentation by the app interaction module.

16. The server of claim 12 wherein presentation of the interaction includes at least one of between items of content of the media stream, concurrently with the presentation of the media stream, during presentation of downloaded content, and while playing a game.

17. The server of claim 12 wherein the app service module includes natural language understanding software.

18. The server of claim 12 wherein the app service module is configured to provide as a third device instruction a further interaction initiation module that presents a further interaction to the user over the user device.

19. The server of claim 12 wherein the app service module is configured to create the third device instructions based on an end-user voice response and available data about previous interaction of the user and data about the remote device.

20. The server of claim 12 wherein the app service module is configured to create a voice response to the user.

21. The server of claim 12 wherein the app interaction module is configured to collect and processes data related to previous end-user interactions, data available about the end-user, and data received from the remote device, and use the collected data to generate the second device instructions to present a customized interaction.

22. The server of claim 12 wherein the app interaction module is configured to create second device instructions to mute the media stream and present an interaction as audio advertisements as a separate audio stream.
